(19) United States
(12) Patent Application Publication
(10) Pub. No.: US 2013/0151072 A1
(43) Pub. Date: Jun. 13, 2013

(54) EYE BREAKAWAY PREVENTION SYSTEM FOR USE WHILE DRIVING A VEHICLE

(71) Applicants: Young Hyun JEONG, Hwaseong (KR); Seong Gyu KANG, Hwaseong (KR); Soo Hwan KIM, Hwaseong (KR); Kyung Kee KIM, Hwaseong (KR); Seung Hwan LEE, Hwaseong (KR)

(72) Inventors: Young Hyun JEONG, Hwaseong (KR); Seong Gyu KANG, Hwaseong (KR); Soo Hwan KIM, Hwaseong (KR); Kyung Kee KIM, Hwaseong (KR); Seung Hwan LEE, Hwaseong (KR)

(73) Assignee: Hyundai Motor Company, Seoul (KR)

(21) Appl. No.: 13/585,977

(22) Filed: Aug. 15, 2012

(30) Foreign Application Priority Data
Dec. 7, 2011 (KR) 10-2011-0130534

(51) Int. Cl. G06F 3/041

(52) U.S. Cl. 701/36

(57) ABSTRACT

Disclosed is an eye breakaway prevention system for use while driving a vehicle. More particularly, the eye breakaway prevention system allows a driver to operate or monitor the functions of a vehicle without diverting their eyes from the area in front of the vehicle (i.e., the direction of the road) when selecting one or more functions or checking the side mirrors and the dashboard while driving. The eye breakaway prevention system during vehicle's driving includes a function selection unit that is disposed on a steering wheel in a vehicle, selects a corresponding function and operation in accordance with an operation by a driver's finger, and outputs a corresponding signal. A control unit controls the function and operation selected by the driver in response to the signal output from the function selection unit; and a function performing unit performs the function corresponding to a control signal outputted from the control unit.

### CROSS-REFERENCE TO RELATED APPLICATION

This application claims under 35 U.S.C. §119(a) the benefit of Korean Patent Application No. 10-2011-0130534 filed on Dec. 7, 2011, the entire contents of which are incorporated herein by reference.

### BACKGROUND

(a) Technical Field

The present invention relates to an eye breakaway prevention system for use while driving a vehicle. More particularly, it relates to an eye breakaway prevention system that allows a driver to operate or monitor certain functions in a vehicle without diverting their eyes from the area in front of the vehicle (i.e., the road) when selecting various functions within the vehicle or monitoring the side minors and the dashboard while driving.

(b) Background Art

In general, vehicles are provided with not only the necessary functions for physically operating the vehicle, but also other various entertainment, air quality and driving assistance functions as well. For example, most vehicles include some form of audio system that allows the driver to listen to various music sources and an air conditioning system that controls the interior temperature. More recently, vehicles have begun to become equipped with a navigation system as well, which informs the driver of the present location and various directions from their current position to an input destination. Additionally, video devices have also become popular in vehicles as well. Therefore, ergonomically speaking, the operating controls for these various functions are often located in a position which is readily accessible and convenient for the driver.

FIG. 1 is a forward facing view illustrating an example of a conventional vehicle function selection device, in which a function operation device is positioned so that the driver can ergonomically operate the device. As shown in FIG. 1, the function operation device is usually positioned at the center portion of the dashboard 1 in the vehicle.

Further, the function operation device 2 may be a typical button type function operation device, as shown in FIG. 2, which includes a display unit 3 that displays selected functions and a function operation unit 2 composed of a plurality of operation buttons 4 and a dial 5 and disposed under the display unit 3. Therefore, a driver selects a desired function by operating the corresponding function of the button 4 or the dial 5 and monitors the desired function from the information displayed on the display unit 3.

However, according to the function operation unit 6 in order for a driver to select a desired mode by operating the function operation unit 6 to perform or change the functions the driver must take their eyes of the road and hands off the steering wheel in order to operate the function operation unit 6. Some of these operating devices are more complicated than others and thus the amount of time that the driver has to take their eyes off the road can be significant in order for the driver to achieve their desired functions. Furthermore, because these devices are located typically in the center of the dashboard, in order for the driver to even monitor the device, the driver has to take their eyes off the road. Thus, as these devices get more complex, it is necessarily for automotive manufactures to come up with a more ergonomic system which allows the driver to keep their eyes on the road while still operating these functions.

### SUMMARY OF THE DISCLOSURE

The present invention has been made in an effort to solve the above-described problems associated with prior art. It is an object of the present invention to provide an eye breakaway prevention system while driving the vehicle which allows a driver to easily operate various functions of a vehicle without diverting their eyes from the area in front of the vehicle e.g., the road, by disposing a function selection unit for the driver to operate the functions with their fingers on the steering wheel, and allow the driver to monitor the side mirrors or the dashboard without diverting their eyes from in front of the vehicle while driving, thereby reducing the possibility of a traffic accident.

In order to achieve the object of the present invention, an eye breakaway prevention system includes a function selection unit that is disposed on a steering wheel in a vehicle. The function selection unit is configured to select corresponding functions and operations in accordance with an operation of a driver's finger. The function selection unit then outputs a corresponding signal based upon these selections accordingly. A control unit is configured to control the function and operation selected by the driver in response to the signal output from the function selection unit; and a function performing unit is configured to perform the function corresponding to a control signal outputted from the control unit.

The system may further include, a photographing device that is configured to image regions blocked by an A filler unit in a vehicle. A display device may be disposed at the A filler unit in the vehicle and configured to display the video taken by the photographing device. The system may further include a camera that is disposed on the outer side of the vehicle and images the side and rear areas of the vehicle, and a video device that is disposed in the vehicle and shows the images of the side and rear areas which are taken by the camera.

Furthermore, a warning light forming portion may be formed in a ceramic line at the lower end of the windshield glass of a vehicle, and further include a head-up display that is disposed on the dashboard positioned ahead of the steering wheel in a vehicle. The heads up display may implement various items of information that are necessary while driving on the windshield of the vehicle or further includes a video output unit that is disposed on the dashboard positioned ahead of the steering wheel in a vehicle that displays a speed indicator or a warning light in the ceramic line of the vehicle.

The function selection unit may be divided into a main function selection unit and a property function selection unit for selecting the sub-property of a function selected by the main function selection unit. The main function selection unit and the property function selection unit may be disposed on the left and right sides of the front side of the steering wheel in locations that are easily accessible by the driver.

Advantageously, it is possible to easily monitor various items of information in a vehicle without diverting the drivers from an area in front of the vehicle by using the function selection unit disposed on the steering wheel and to easily monitor the side and rear areas of the vehicle and the traveling information from the video device disposed in the A filler unit on the driver's side of the vehicle, as well as the warning light, the speed indicator, and the head-up display in the ceramic line, without diverting the driver's eyes from the area in front vehicle, so that it is possible to reduce the possibility of a traffic accident due to the driver's eyes from the area in front of the vehicle.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating the interior of a vehicle equipped with a function selection device in the related art.

FIG. 2 is a front view illustrating an example of a function selection device of a vehicle of the related art.

FIG. 3 is a view illustrating the interior of a vehicle equipped with an eye breakaway prevention system during vehicle's driving according to the present invention.

FIG. 4 is an enlarged view of the portion A shown in FIG. 3.

FIG. 5A is an enlarged view of an example of the portion B shown in FIG. 3.

FIG. 5B is an enlarged view of another example of the portion B shown in FIG. 3.

FIG. 6 is a block diagram showing the connection of a function selection unit, a control unit, a display unit, and a function performing unit according to the present invention.

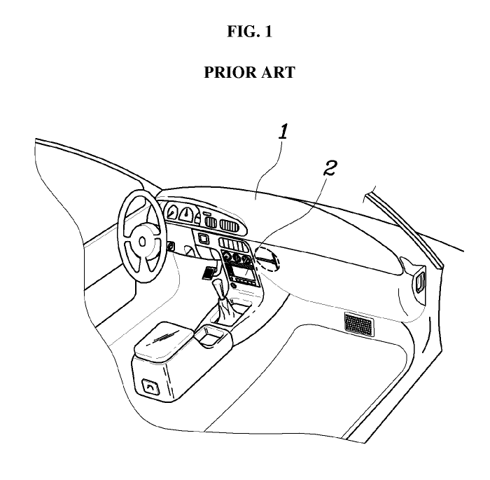

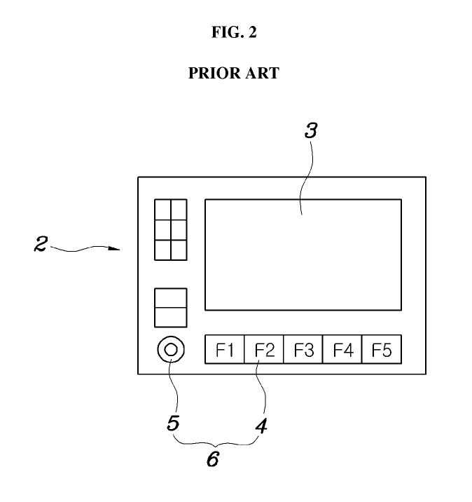

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, an eye breakaway prevention system according to the present invention is described in detail with reference to the accompanying drawings. In describing the present invention, well-known functions or constructions will not be described in detail since they may obscure the understanding of the present invention. Further, the terminologies described below were defined in consideration of the function of the present invention and may be different in accordance with the intention of the manufacturers of products or the custom.

The present invention has been designed to reduce the possibility of a traffic accidents by preventing a driver from diverting the driver's eyes from the area in front of the vehicle (i.e., the road) when operating various functions of a vehicle or monitoring the dashboard or the side minors while driving.

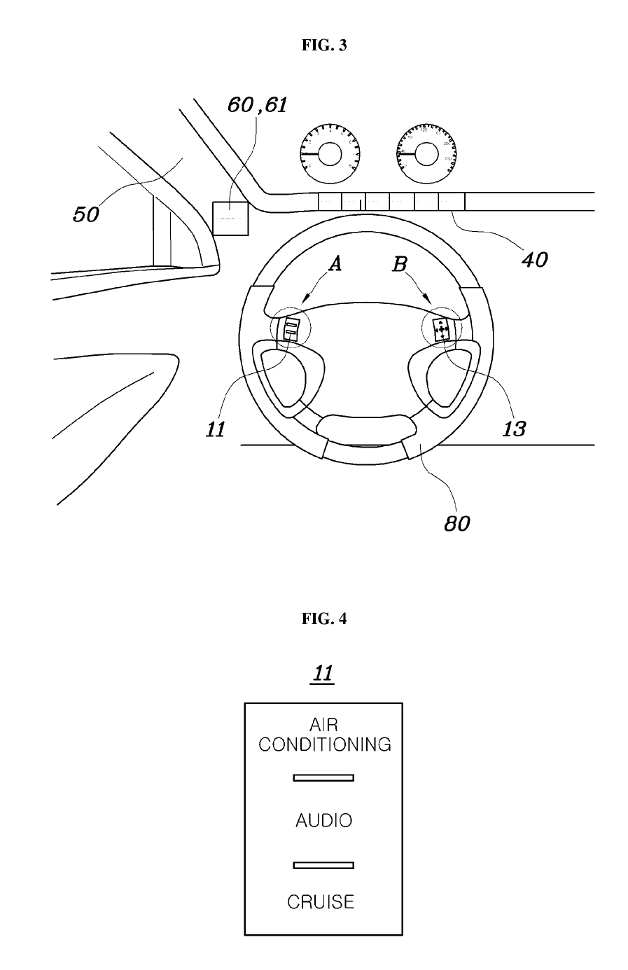

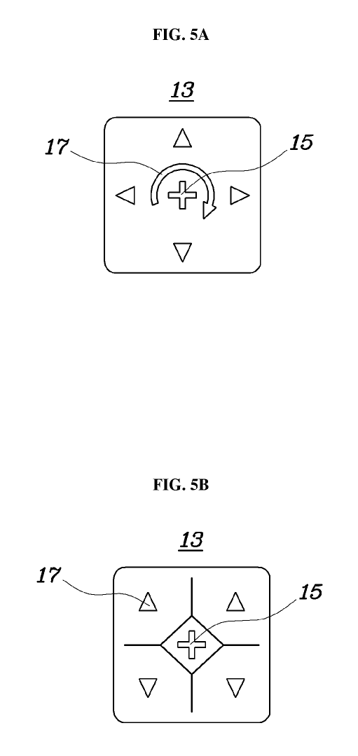

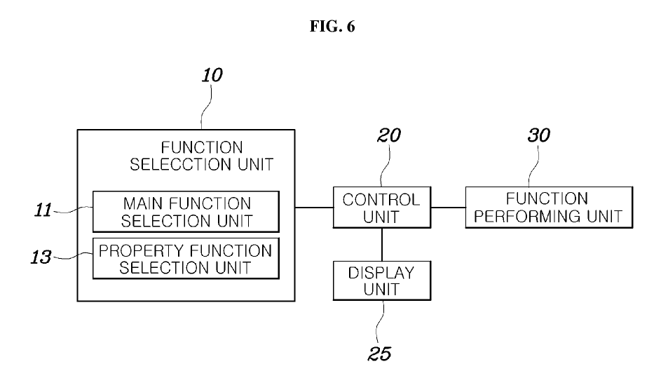

FIG. 3 is a view showing the interior of a vehicle equipped with an eye breakaway prevention system while driving a vehicle according to the present invention, FIG. 4 is an enlarged view of the portion A shown in FIG. 3, FIG. 5A is an enlarged view of an example of the portion B shown in FIG. 3, FIG. 5B is an enlarged view of another example of the portion B shown in FIG. 3, and FIG. 6 is a block diagram showing the connection of a function selection unit, a control unit, a display unit, and a function performing unit according to the present invention.

As shown in FIGS. 3 to 6, an eye breakaway prevention system according to the present invention allows a driver to monitor various operations, traveling information, and the outside environment of a vehicle without the driver having to diverts his or her eyes from an area in front of a vehicle while driving, by disposing a function selection unit on the steering wheel and disposing a display device in an A filler unit of the vehicle to see the outside environment so that various items of information, which can be monitored from the dashboard, are projected on the windshield glass of the vehicle.

As illustrated in FIG. 3, a function selection unit 10 is disposed on a steering wheel 80 of a vehicle and operated by the driver's fingers to select a desired function and operation, and outputs corresponding signals accordingly. That is, the function selection unit 10 allows the driver to operate the audio system, the air-conditioning control, cruise control, telephone function, and other controllable functions in the vehicle, with the driver's fingers while driving.

Further, the function selection unit 10 is divided into a main function selection unit 11 and a property function selection unit 13 that allows the driver to select sub-properties of the function s selected by the main function selection unit 11, in which the main function selection unit 11 and the property function selection unit 13 are disposed on left and right side of the front surface of the steering wheel so that the driver can reach the steering wheel with one or more fingers while holding the steering wheel with both hands.

The main function selection unit 11 may be disposed on the left side of the front surface of the steering wheel 80 and the property function selection unit 13 may be disposed on the right side of the front of the steering wheel 80. Alternatively, the main function selection unit 11 may be disposed on the right side of the front surface of the steering wheel 80 and the property function selection unit 13 may be disposed on the left side surface of the front of the steering wheel 80. Thus, it is possible to dispose the main function selection unit 11 and the property function selection unit 13 at appropriate positions for ease of manufacturing or user convenience.

Furthermore, the main function selection unit 11 and the property function selection unit 13 may be implemented by a general push button type switch, a touch pad that performs a predetermined function when the driver's body touches it, or a touch input device, such as a touch screen. Further, the main function selection unit 11 may be implemented by a push button type switch and the property function selection unit 13 may be implemented as a touch input device.

The operation of the function selection unit 10 is described hereafter under the assumption that the main function selection unit 11 implemented in a push button type switch is disposed on the left side of the steering wheel 80 and the property function selection unit 13 implemented as a touch input device is disposed on the right side of the steering wheel 80.

Large group functions are implemented by the main function selection unit 11 when the functions of the vehicle are selected. That is, as shown in FIG. 4, the functions, such as an audio, air-conditioning control, and cruise control of a vehicle are implemented, so that the driver can operate the main function selection unit 11 while holding the sides of the steering wheel 80 with hands.

Further, the property function selection unit 13 makes it possible to select the sub-functions of the functions selected by the main function selection unit 11, so that the driver can adjust the amount of wind and temperature, and switch between cooling/heating modes after pushing the air-conditioning portion of the main function selection unit 11, through the property function selection unit 13.

The property function selection unit 13 implemented by a touch input device is centered so that the user can accurately recognize the center of the property function selection unit 13 only by touching it with one or more fingers while still holding the steering wheel 80 with both hands while driving, so that the driver does not divert their eyes from the area in front of the vehicle when adjusting the position of the property function selection unit 13 while easily operating the property function selection unit 13.

The property function selection unit 13 is described as an example with reference to FIG. 5A. The property function selection unit 13 is provided with a pattern unit that guides the driver's manipulation of the unit or in selecting the functions. For example, a circle may be configured to inform the driver that a temperature is increasing or decreasing by turning the circle clockwise or counterclockwise as marked. Further, triangular arrows may be marked at four corresponding positions above and under and at left and right sides of the circle, so that a touching the up/down buttons indicate to the driver an adjustment of the amount of wind (e.g., adjust the fan in the air-conditioning system), while touching the left or right arrows change the mode of the function selection unit.

It should be understood that it is possible to enlarge or reduce the map displayed on the navigation system mounted on the vehicle by rotating a finger clockwise or counterclockwise on the property function selection unit 13.

Through the exemplary embodiment of the present invention, the driver can select a large group of the main function selection unit 11 and then the sub-property of the function selected from the large group through the property function selection unit 13 only by moving one or more fingers without diverting their eyes from an area in front of the vehicle.

It is possible to further improve the ergonomic nature of the device by applying the same operation method as the switch of a center fascia to the pattern unit of the property function selection unit and it is also possible to display the operational information of the property function selection unit in a display unit of a center fascia or in a ceramic line, which is described below, or display the information by using a head-up display.

Further, another embodiment of the property function selection unit 13 is described with reference to FIG. 5B. The property function selection unit 13 is provided with the pattern unit 17 that guides the driver moving a finger or selecting a function, in which a diagram including a center recognition button formed at the center of the property function selection unit and straight separation lines are formed up and down and left and right at four positions from the outline of the diagram. Therefore, four sections are formed around the diagram including the center recognition button 15 on the property function selection unit 13 and triangular arrows for indicating the direction are marked in the sections.

The diagram including the center recognition button 15 may be provided to guide a mode change and the triangular arrows at the left and right of the center recognition button 15 may be provided to control the temperature in the vehicle. For example, the upper and lower triangular arrows may be configured to control the amount of wind from either a fan within the air conditioning system.

Therefore, the driver can select a large group of the main function selection unit 11 and then the sub-property of the function selected from the large group through the property function selection unit 13 only by moving one or more fingers without diverting their eyes from the area in front of the vehicle.

It should be understood that the pattern unit 17 formed at the property function selection unit 13 may be formed by patterns other than those described in the embodiments described above. Further, when the main function selection unit 11 is implemented as a touch type input device, it may be possible to allow the user to input only the initial letter of the corresponding group for rapid operation of the large groups. That is, it is possible to select air-conditioning control, audio, and cruise control only by inputting “Ai’, “Au”, and “C”, respectively, with a finger on the main function selection unit 11.

Further, when the main function selection unit 11 and the property function selection unit 13 are implemented by a touch type, it is possible to provide an antitheft function by making it possible to set a password on the two selection units. In this case, it may be possible to provide sound guidance for the selected function or allow the user to operate the sub-property menu while touching or pressing the main menu with a finger.

That is, it is possible to prevent the vehicle from being stolen by providing a function that requires the driver to input a password on the steering wheel before the steering wheel is unlocked, by making it possible to store a predetermined password, such as patterns, numbers, symbols, or initial letters in the two selection units so that the steering wheel remains locked until the correct password is entered even once the engine starts.

As another example of providing a function that allows the steering wheel can be operated, it may be possible to allow only a driver whose information is registered to operate the steering wheel by requiring user recognition through a terminal with a Bluetooth function.

Further, the control unit 20 controls the function and operation selected by the driver in response to signals outputted by the driver operating the function selection unit 10. The control unit 20 may be connected with a display unit 25 that allows the driver to check the functional and operational state selected from the function selection unit 10 and it may be preferable to dispose the display unit 25 at the upper portion of the dashboard in the vehicle so that the driver does not excessively divert their eyes from the area in front of the vehicle.

Further, the function performing unit 30 performs the function corresponding to the control signal output from the control unit 20 and is electrically connected with the control unit 20 so that the control signal of the control unit 20 can be transmitted. For example the function performing unit electrically connected with the control unit 20 is usually the air conditioning system, the audio system, the cruise system, the telephone device, and various devices in the vehicle.

Describing the operation through the steering wheel implemented as described above, the driver touches the function selection unit 10 on the front of the steering wheel 80 with a finger of the hand holding the steering wheel 80 in order to operate a necessary convenience function while driving a vehicle. When touched by a finger of the driver, the function selection unit 10 senses the touch and outputs a signal corresponding to the touched point, the output signal is inputted to the control unit 20, and the control unit outputs the control signal to the display unit 25 to inform the driver of the function selected by the driver. A message indicating the corresponding function may be displayed on the display unit 25 in response to the control signal transmitted from the control unit 20, so that the driver can monitor the function that he/she has selected while driving. In this process, since the display unit 20 is disposed on the dashboard within in an area that does not require the driver to divert their eyes from the road, it is possible to easily observe the message on the display unit without diverting one's eyes from an area in front of the vehicle while driving.

Further, the control unit outputs a control signal for performing the function selected by the driver to the function performing unit 30 and the function performing unit 30 performs the function corresponding to the control signal.

In some exemplary embodiments, according to the present invention, it is possible to image the outside environment of a vehicle that is blocked by the A filler unit 50 of the vehicle with a photographing device and to safely monitor blind spots of the vehicle while driving by equipping the A filler unit on the driver's side of the vehicle with a display device 60 that can display the recorded video. It is possible to check the display device 60 without diverting the driver's eyes from the area in front of the vehicle as little as possible while driving, so that it is possible to remarkably reduce the possibility of traffic accidents due to the driver diverting their eyes.

The photographing device may be disposed in the A filler units outside the driver's seat and the passenger's seat in a vehicle and is not given a reference numeral in the drawings. Further, the display device 60 may be implemented to display two videos on one screen to show the videos taken by the photographing devices in the A filler unit outside the driver's seat and the A filler unit outside the passenger's seat.

Further, according to the present invention, it may be possible to monitor the video taken by a camera through a video device disposed in the A filler unit 50 on the driver's side of the vehicle in order to prevent the driver from diverting their eyes from the area in front of the vehicle to look at the side minor while driving. The video device 61 may be disposed at the same position as the display device 60 described above and perform the same function.

That is, the camera may be disposed on the outer side of the vehicle and record images of the side and rear areas of the vehicle. The video device may be disposed in the A filler unit in or around the driver's seat in the vehicle and display the images of the side and rear areas of the vehicle which are taken by the camera to the driver. Therefore, the driver can easily check the side and rear areas of the vehicle from the video device disposed in the A filler unit on the driver's side of the vehicle while still looking at the area in front of the vehicle, without turning their head to check the side mirrors.

Further, in the present invention, a warning light forming portion 40 may be formed on the windshield glass of the vehicle, that is, in the ceramic line at the lower end of the windshield of the vehicle and a head-up display that provides various items of information that are necessary while driving on the windshield of the vehicle is disposed on the dashboard positioned in front of the steering wheel 80. That is, since a driver has to monitor the dashboard in order to check various items of information (such as, speed, RPM, fuel) of the vehicle while driving and he or she must often divert their eyes from the area in front of the vehicle in the conventional art, according to the present invention, the warning light forming portion 40 or a speed indicator is disposed in the ceramic line at the lower end of the windshield glass positioned in front of the steering wheel in the vehicle so that the driver can check various items of information without diverting their eyes from the area in front of the vehicle, and various items of information that are necessary while driving are implemented on the windshield glass by the head-up display. Further, it may be possible to show a speed indicator or a warning light in the ceramic line in the vehicle from a video output unit by disposing the video output unit on the dashboard positioned in front of the steering wheel in the vehicle.

As described above, the present invention can reduce the possibility of an accidents due to a driver diverting his or her the eyes from the area in front of the vehicle by allowing a driver to perform various functions and monitor the side and rear areas and the dashboard without diverting their eyes from the area in front of the vehicle, when performing various functions or monitoring the side and rear areas from the side mirrors and the dashboard.

While the invention has been described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. An eye breakaway prevention system during vehicle's driving, comprising:
a function selection unit disposed on a steering wheel in a vehicle, and configured to select corresponding functions and operations in accordance with an operation by a driver's finger, and output a corresponding signal based on the operation of the driver's finger;
a control unit configured to control the function and operation selected by the driver in response to the signal output from the function selection unit; and
a function performing unit configured to perform the function corresponding to a control signal outputted from the control unit.

2. The system of claim 1, wherein the function selection unit is divided into a main function selection unit and a property function selection unit configured to select a sub-property of a function selected by the main function selection unit.

3. The system of claim 2, wherein the main function selection unit and the property function selection unit are disposed on the left and right sides on the front surface of the steering wheel where the driver can reach each respectively with at least one finger.

4. The system of claim 2, wherein the function selection unit is a touch input device that performs a predetermined function when being touched by the driver's finger.

5. The system of claim 4, wherein the function selection unit is provided with a center recognition button for recognizing a center portion thereof.

6. The system of claim 4, wherein the function selection unit is provided with a pattern unit configured to guide a user's movement of a finger or function selection.

7. The system of claim 1, further comprising a warning light forming portion formed in a ceramic line at a lower end of a windshield glass of a vehicle.

8. The system of claim 1, further comprising a video output unit disposed on a dashboard positioned in front of the steering wheel in a vehicle and configured to display a speed indicator or a warning light in a ceramic line of the vehicle.

9. The system of claim 1, further comprising:
a photographing device configured to record image regions blocked by an A filler unit on a driver's side of a vehicle; and
a display device disposed in the A filler unit on the driver's side of the vehicle and configured to display video taken by the photographing device.

10. The system of claim 1, further comprising:
a camera disposed on the outer side of the vehicle and configured to record images of side and rear areas of the vehicle; and
a video device disposed in the A filler unit on the driver's side of the vehicle and displays the images of side and rear areas which are taken by the camera.

11. The system of claim 1, further comprising a head-up display disposed on the dashboard positioned in front of the steering wheel in a vehicle and configured to display various items of information that are necessary while driving on a windshield of the vehicle.
